(19) United States
(12) Patent Application Publication
(10) Pub. No.: US 2025/0118170 A1
(43) Pub. Date: Apr. 10, 2025

(54) FIVE CARD ROULETTE

(71) Applicant: Eric Bryant Johnson, Sandston, VA (US)

(72) Inventor: Eric Bryant Johnson, Sandston, VA (US)

(21) Appl. No.: 18/904,119

(22) Filed: Oct. 2, 2024

Related U.S. Application Data
(60) Provisional application No. 63/629,301, filed on Oct. 6, 2023.

(51) Int. Cl. G07F 17/32

(52) U.S. Cl. CPC G07F 17/3293

(57) ABSTRACT

A method of playing a wagering card game includes dealing a card face down on a table; requiring a player to place a color wager prior to the card being turned over; providing a player with an option, prior to the card being turned over, to place one or more additional wagers predicting the face value of the card dealt face down on the table; turning the card over to reveal the face value of the card; resolving the color wager by paying a payout based on the color wager if the card is the same color as the color wager; and resolving the one or more additional wagers if placed by paying a payout based on the one or more additional wagers if the value of the card is the same as any of the predicted values.

### CROSS-REFERENCE TO RELATED APPLICATION

This application claims the benefit of U.S. Application No. 63/629,301, filed Oct. 6, 2023, the entire contents of which is incorporated herein by reference.

### TECHNICAL FIELD

The invention relates to a wagering card game and, more particularly, a wagering card game that incorporates aspects of the traditional roulette game.

### BACKGROUND

Casino operators are continually searching for ways to make casino table games more attractive and player friendly. Games such a Roulette provide players with the excitement of multiple betting opportunities. However, such games are not equipped with any sort of seating arrangements or designated spaces for players. In addition, the table must be large enough to accommodate all of the aspects of the game. Accordingly, at least for games such as Roulette, players must remain standing and reach over portions of the table just to play. Over time, players can get tired from standing or can strain their backs due to having to reach over the table to position their playing pieces and make bets. Such a condition discourages players from spending long amounts of time at any Roulette table and thus limits the amount of money being wagered by individual players.

On the other hand, house-banked wagering card games use more compacted tables that don't require excessive reaching over portions of the table. In addition, such compact tables utilize designated player stations with seating arrangements, which encourage players to spend longer times at the table.

Combining the excitement of multiple betting opportunities with the more ergonomically beneficial arrangements of wagering card game tables would provide enticing wagering games while also encouraging players to spend a longer amount of time at the wagering game table.

### BRIEF SUMMARY OF THE INVENTION

The game may be a house banked game played with a standard deck of fifty-two poker playing cards, with an option of one, two, or three jokers in addition to the fifty-two poker playing cards. Up to five players may play the game at the same time (in addition to the dealer). During play, the dealer draws five “community” cards and turns them over one at a time to reveal their value. The players place bets on which card and/or what color card will be revealed next (color wager). Players can also place bets on whether the five “community” cards will result in a Poker hand (e.g., Full House, Flush, etc.).

In one aspect of the invention, a method of playing a wagering card game includes dealing a card face down on a table; requiring a player to place a color wager prior to the card being turned over; providing a player with an option, prior to the card being turned over, to place one or more additional wagers predicting the face value of the card dealt face down on the table; turning the card over to reveal the face value of the card; resolving the color wager by paying a payout based on the color wager if the card is the same color as the color wager; and resolving the one or more additional wagers if placed by paying a payout based on the one or more additional wagers if the value of the card is the same as any of the predicted values.

A further aspect of the invention includes the preceding aspect and wherein, the one or more additional wagers are limited to the color chosen in the color wager.

A further aspect of the invention includes any of the preceding aspects and wherein, the one or more additional wagers are limited to the color chosen in the color wager except for when the one or more additional wager predicts a Joker.

A further aspect of the invention includes any of the preceding aspects and wherein, the amount of money wagered for each of the one or more additional wagers is limited to the amount of money wagered for the color wager.

A further aspect of the invention includes any of the preceding aspects and wherein, the available face value choices for the one or more additional wagers are:
(a) 2 through 6,
(b) 7 through Jack,
(c) Queen through King,
(d) Ace, and
(e) Joker.

A further aspect of the invention includes any of the preceding aspects and wherein, the payout for wagers that choose 2 through 6 and 7 through Jack is less than the payout for wagers that choose Queen through King, and wherein the payout for wagers that choose Queen through King is less than wagers that choose Ace or Jack.

A further aspect of the invention includes any of the preceding aspects and wherein, the payout is least for the color wager.

A further aspect of the invention includes any of the preceding aspects and wherein, the number of players playing the game is 1 to 5, each player is required to place a color wager prior to the card being turned over, and each player is provided with the option, prior to the card being turned over, to place one or more additional wagers predicting the face value of the card dealt face down on the table.

In yet another aspect of the invention, a method of playing a multi-round wagering card game includes dealing a plurality of cards face down on a table; performing a first round by requiring a player to place a color wager prior to any of the cards being turned over to reveal the face value of a first card; providing the player with an option, prior to any of the cards being turned over, to place one or more additional wagers predicting the face value of the first card; providing the player with an option, prior to any of the cards being turned over, to place a community wager that pays out if the plurality of cards form a Poker hand; turning said first card over to reveal the card; resolving the color wager by paying a payout based on the color wager if the first card is the same color as the color wager; and resolving the one or more additional wagers if placed by paying a payout based on the one or more additional wagers if the value of the first card is the same as any of the predicted values; performing a second round by: requiring the player to place another color wager prior to turning over a next one of the cards that are dealt face down; providing the player with an option, prior to said next card being turned over, to place one or more additional wagers predicting the face value of said next card; turning said next card over to reveal the face value of said next card; resolving said another color wager by paying a payout based on said another color wager if said next card is the same color as said another color wager; and resolving the one or more additional wagers, if placed, by paying a payout based on the one or more additional wagers if the value of said next card is the same as any of the predicted values; performing additional rounds until all of the cards that are dealt face down are turned over, the additional rounds being performed by repeating the steps performed in the second round; and resolving the community wager, if placed, by paying a payout based the community wager if the plurality of cards form a Poker hand.

A further aspect of the technology includes the preceding aspect and wherein, the number of cards that are dealt face down is five.

A further aspect of the technology includes any of the preceding aspects and wherein, the number of rounds played for a game is five.

A further aspect of the technology includes any of the preceding aspects and wherein, the one or more additional wagers are limited to the color chosen in the color wager.

A further aspect of the technology includes any of the preceding aspects and wherein, the one or more additional wagers are limited to the color chosen in the color wager except for when the additional wager predicts a Joker.

A further aspect of the technology includes any of the preceding aspects and wherein, the amount of money wagered for each of the one or more additional wagers is limited to the amount of money wagered for the color wager.

A further aspect of the technology includes any of the preceding aspects and wherein, the available face value choices for the one or more additional wagers are:
(a) 2 through 6,
(b) 7 through Jack,
(c) Queen through King,
(d) Ace, and
(e) Joker.

A further aspect of the technology includes any of the preceding aspects and wherein, the payout for wagers that choose 2 through 6 and 7 through Jack is less than the payout for wagers that choose Queen through King, and wherein the payout for wagers that choose Queen through King is less than wagers that choose Ace or Jack.

A further aspect of the technology includes any of the preceding aspects and wherein, the Poker hands include, Five of a Kind, Royal Flush, Straight Flush, Four of a Kind, Full House, Flush, Straight, and All the same color.

A further aspect of the technology includes any of the preceding aspects and wherein, a Royal Flush with a Joker has a different payout from a Royal Flush without a Joker.

A further aspect of the technology includes any of the preceding aspects and wherein, the payout is least for the color wager.

A further aspect of the technology includes any of the preceding aspects and wherein, the number of players playing the game is 1 to 5, each player is required to place a color wager prior to said next card being turned over, each player is provided, prior to said next card being turned over, with the option to place one or more additional wagers predicting the face value of the card dealt face down on the table, and each player is provided, prior to any of the cards being turned over, with the option to place a community wager that pays out if the plurality of cards form a Poker hand.

### BRIEF DESCRIPTION OF THE DRAWINGS

These and other aspects and advantages will be described in detail with reference to the accompanying drawings:

FIG. 1 is an exemplary table layout suitable for playing the wagering game of the preferred embodiments.

FIG. 2 is a close up view of a section of the table of claim 1.

### DETAILED DESCRIPTION OF THE INVENTION

In the following detailed description, the method and apparatus according to the present invention will be described in conjunction with its application to a casino environment, thus incorporating wagers, payouts etc. Those of ordinary skill in the art will readily comprehend alternative applications of the present invention outside a casino environment, and the invention is not necessarily meant to be limited to the described application. For example, the game may be embodied in a video game that is played for entertainment purposes against a computer or the like. Alternatively, players may play the game without wagers in a head-to-head format with one player acting as a dealer, and the other player simply keeping track of wins and losses.

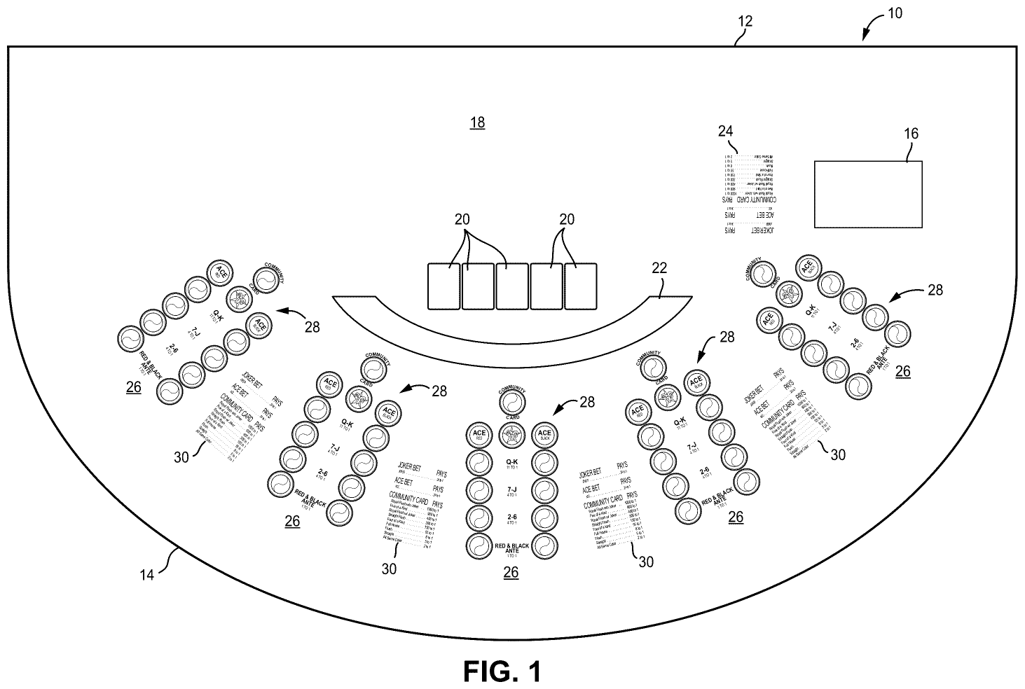

FIG. 1 shows a game table 10 including a dealer side 12 and a player side 14 opposite the dealer side 12. The dealer and the players may be positioned on opposite sides of the table 10. The table 10 is shown as having a straight edge on the dealer side 12 and a convex edge on the player side 14. However, it is contemplated that the edge of the dealer side 12 may be concave or may include a recessed region in which the dealer is positioned. In addition, the edge of the player side 14 may be straight or may include a plurality of straight edges separated by vertexes (similar to the sides of a polygon).

One or more promotional markings 16 may be located anywhere on the table. The promotional markings 16 may include the game's name, a logo, a slogan or any other markings that may identify and/or promote the game.

A dealer playing area 18 may be located adjacent to the dealer playing side 12 and may include a plurality of community card boxes 20, indicia 22 describing the game rules, and indicia 24 describing the payout for certain card combinations. The community card boxes 20 may be sized and shaped to match conventional playing cards (e.g., rectangular) and may be formed from lines drawn on the table 10. Alternatively, the community card boxes 20 may be in the form of three-dimensional containers. In addition, the community card boxes 20 may be arranged in a line in a central region of the table 10. It is contemplated that the community card boxes 20 may be arranged in a different pattern and may be located at a different region of the table 10. The number of community card boxes 20 may be the same as the total number of community cards played during the game (e.g., five community card boxes 20).

The indicia 22 may include one or more separate regions in the dealer playing area 12. For example, the indicia 24 may be a single region located between the community card boxes 20 and the player side 14. In the illustrated example, the indicia 22 is arranged in arc. However, the indicia 22 may be arranged in any shape. The indicia 22 may include game rules such as, for example, the rules for placing a bet. The indicia 22 may face the player side 14 so that the indicia 22 is readable by the players.

The indicia 24 may be located separate from the indicia 22. For example, the indicia 24 may be located between the community card boxes 20 and the promotional marking 16 or the lateral side of the table 10. The indicia 24 may include payout guidelines and may face the dealer side 20. For example, the indicia 24 may include payout guidelines for different combinations of the community cards.

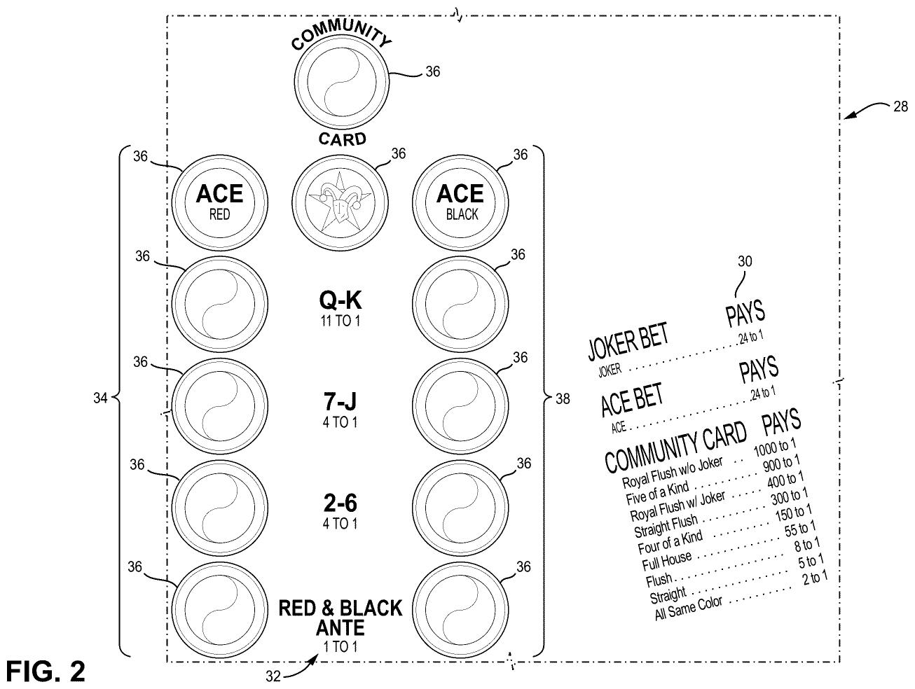

The player side 14 of the table 10 may include one or more player playing areas 26. For example, the number of player playing areas 26 may be five. Each player playing area 26 may include a wager area 28, a first payout indicia 30, and a second payout indicia 32. As shown in FIG. 2, each wager area 28 may include first column 34 of wager markers 36 and a second column 38 of wager markers 36. In the illustrated configuration, the first and second columns 34, 38 are side by side. However, the first and second columns 34, 38 may be positioned in different arrangements.

Each wager marker 36 may be in a shape similar to a token or chip that may be used for wagering. For example, the wager marker 36 may be circular. Each wager marker 36 may designate a space on the table 10 on which the player may place a token or chip to indicate which type of bet the user intends to make. Each wager marker 36 may correspond to a particular card or group of cards. In addition, the first column 34 may correspond to red cards, while the second column 38 may correspond to black cards. In the example illustrated in FIG. 2, four of the wager markers 36 respectively correspond to all red cards, all black cards, red 2 through 6 cards, black 2 through 6 cards, red 7 through Jack cards, black 7 through Jack cards, red Queen through King cards, black queen through King, red Ace cards, and black Ace cards. However, the wager markers 36 are not limited to the groupings shown in FIG. 2. For example, more or less wager markers 36 may be included in first and second columns 34, 38 so that each wager marker 36 corresponds to a single card or ranges of cards that are different from the ranges identified in FIG. 2.

Two additional wager markers 36 may be included in the player playing area 26. Those two wager markers 36 may be located outside of the first and second columns 34, 38. One of the two additional wager markers 36 may correspond to a Joker, while the other of the two additional wager markers 36 may correspond to the entire set of community cards.

The indicia 30 may be located between wager areas 28 and may be similar to the indicia 24. That is, the indicia 30 may include payout guidelines for different combinations of the community cards. The indicia 32 may be located between the first and second columns 34, 38 and may include payout guidelines for the different cards associated with the wager markers 36.

In one configuration, the game may be a house banked game played with a standard deck of fifty-two poker playing cards, with an option of one, two, or three jokers in addition to the fifty-two poker playing cards. Up to five players may play the game at the same time (in addition to the dealer). During play, the dealer draws five “community” cards. The game may include multiple rounds with each round corresponding to a “community” card (e.g., five rounds for five “community” cards). In each round all of the players place bets on which card will be revealed during that round, and the dealer turns over one card to reveal its value. Players can also place bets on whether the five “community” cards will result in a Poker hand (e.g., Full House, Flush, etc.)

To begin play, a first player (the player farthest to the left (dealer's right)) may place an ante wager by placing a chip or token on one of the wager markers 36. For example, the chip or token for the ante wager may be placed on the wager marker 36 corresponding to all black cards or on the wager marker 36 corresponding to all red cards. In other words, the ante wager may be a color wager. The ante wager must be placed before any other wager is placed. In other words, placing the ante wager allows the player to participate in the game. In addition, the ante wager may set the value of any other bet made by the player. That is, any additional bet (or wager) must have same value as the ante wager. Alternatively, the value of the additional bets may be greater than, less than, or the same as the ante wager.

Once the first ante wager is placed, the first player may place additional bets by placing tokens or chips on other wager markers 36. Each wager marker 36 corresponds to a possible value or range of values of the “community” card that is to be drawn for that round. It should be understood that the additional bets are optional. In addition, as discussed above, the amount of each additional bet cannot exceed or be below the amount of money wagered in the ante wager. In addition, it is contemplated that the additional bets may be limited by the color chosen by the ante wager. For example, if the ante wager is Red Ante, the player is limited to only Red color bets (e.g., Red 2-6, Red 7-J, Red Q-K, Red Ace).

Alternatively, the additional bets might not be limited by the color chosen by the ante wager. In addition, the Joker wager marker 36 may be selected regardless of which color is chosen during the ante wager phase because jokers are not associated with any color.

During the first round only (and especially prior to the first “Community” card being revealed), the player may place a token or chip on the “community” wager marker 36 to make a Community Card bet. The player makes the Community Card bet when they believe the five “Community” cards will reveal a poker hand that qualifies using the following payout table:

| Poker Hand Revealed By All | |
|---|---|
| Five Community Cards | Payout |
| Royal Flush without Joker | 1000 to 1 |
| Five of a Kind | 900 to 1 |
| Royal Flush with Joker | 400 to 1 |
| Straight Flush | 300 to 1 |
| Four of a Kind | 150 to 1 |
| Full House | 55 to 1 |
| Flush | 8 to 1 |
| Straight | 5 to 1 |
| All the same color | 2 to 1 |

It should be understood that additional Poker Hands may also payout. Such additional Poker Hands may include a Pair, two Pair, and Three of a Kind.

Once the first player has made their bet (or bets) the next player makes their bet (or bets). The same rules apply to the second player. That is, in order to participate in the game, the second player places an ante wager and then optionally places additional bets by placing tokens or chips on other wager markers 36. This continues until all of the players have made their bets.

After all bets in the round have been made, the dealer draws the five “community” cards and places them on respective community card boxes 20. It is contemplated that the five “community” cards may be drawn prior to the first ante wager as long as all of the “community” cards remain face down during the first round of betting. It is also contemplated that the dealer only draws one card before or after each round of betting. Regardless of when the dealer draws the “community” cards, all of the drawn “community” cards must be face down during the first round of betting so that the value of the “community” cards remains unknown while the betting takes place.

After the dealer reveals the first “community” card, the dealer then determines the winners and losers of that round and either takes the tokens or chips from the wager area 28 of a player playing area 26 (if the player loses the bet) or provides additional tokens or chips to the players depending on the bet (with the exception of the Community card bet, which cannot be settled until all of the “Community” cards have been revealed). The settling of the bets may begin with the dealer taking tokens or chips from the first player or giving the tokens or chips to the first player. An exemplary payout schedule for each round is shown in the following Table:

| “Community” Card Drawn | Wager Marker Chosen | Payout |
|---|---|---|
| Any Black Card | Black Ante | 1 to 1 |
| Any Red Card | Red Ante | 1 to 1 |
| Any Red Card From 2 to 6 | Red 2-6 | 4 to 1 |
| Any Black Card From 2 to 6 | Black 2-6 | 4 to 1 |
| Any Red Card From 7 to Jack | Red 7-J | 4 to 1 |
| Any Black Card From 7 to Jack | Black 7-J | 4 to 1 |
| Any Red From Queen to King | Red Q-K | 11 to 1 |
| Any Black From Queen to King | Black Q-K | 11 to 1 |
| Any Red Ace | Red Ace | 24 to 1 |
| Any Black Ace | Black Ace | 24 to 1 |
| Any Joker | Joker | 24 to 1 |

It should be understood that if the “Community” card is a Joker, the only winning bet will be made by placing the token or chip on the Joker wager marker 36. All other bets lose with the exception of the Community bet. It should also by understood that the Community card bet is not settled until all of the “Community” cards have been revealed.

The settling of the bets completes the first round, and the second round begins with the first player placing another ante wager. Players are not required to place any more ante wagers. However, if no ante wager is placed for a particular round, the player cannot make any bets for that round. Alternatively, if a player does not make an ante wager for a particular, the player cannot make any more bets for the rest of the game.

The game continues until all of the “Community” cards have been revealed and the bets have been settled.

Alternatively, the game continues for one more round (a third round of ante wagers and additional bets, revealing a third “Community” card, and settling of bets). Once the third round is completed, no more betting occurs. Instead, the last two “Community” cards are revealed and the “Community” card bets are settled.

It is contemplated that there may be a minimum bet for the ante wager and the additional bets (e.g., $10 USD). There may also be a maximum bet for the ante wager and the additional bets (e.g., $50 USD). It is further contemplated that the Community card wager may be different from the ante wager and the additional bets (either greater or lower than the ante wager and additional bets). For example, the Community card wager may be limited to a single value that is between and including $1 USD and $5 USD (e.g., the Community card wager may be limited to only $5 USD). Alternatively, the minimum bet for all bets may be between and include $1 USD and $10 USD, while the maximum bet for all bets may be between and include $5 USD and $50 USD.

It is also contemplated that an alternative payout schedule may be made for the Community card bet according to the following Table:

| Poker Hand Revealed By All | |
|---|---|
| Five Community Cards | Payout |
| Five of a Kind | 1000 to 1 |
| Royal Flush | 500 to 1 |
| Straight Flush | 200 to 1 |
| Four of a Kind | 100 to 1 |
| Full House | 50 to 1 |
| Flush | 25 to 1 |
| Straight | 7 to 1 |
| All the same color | 1 to 1 |

As would be apparent to those skilled in the relevant art, the embodiments described above can be embodied in a wide variety of forms and media including, but not limited to, single player slot video machines, multi-player slot video machines, electronic games and devices, lottery terminals, scratch-card formats, software as well as in-flight, home and Internet entertainment. In addition, the described embodiments can also be readily implemented as a computer program product (e.g., floppy disks, compact disks, etc.) comprising a computer readable medium having control logic reported therein to implement the features of the invention as described in relation to the other preferred embodiments. The control logic can be loaded into the memory of a computer and executed by a central processing unit (CPU) to perform the operations described herein.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of playing a wagering card game comprising:
dealing a card face down on a table;
requiring a player to place a color wager prior to the card being turned over;
providing a player with an option, prior to the card being turned over, to place one or more additional wagers predicting the face value of the card dealt face down on the table;
turning the card over to reveal the face value of the card;
resolving the color wager by paying a payout based on the color wager if the card is the same color as the color wager; and
resolving the one or more additional wagers if placed by paying a payout based on the one or more additional wagers if the value of the card is the same as any of the predicted values.

2. The method of claim 1, wherein the one or more additional wagers are limited to the color chosen in the color wager.

3. The method of claim 1, wherein the one or more additional wagers are limited to the color chosen in the color wager except for additional wagers predicting a Joker.

4. The method of claim 1, wherein a minimum bet for the color wager and the one or more additional wagers is $10 USD and the maximum bet for the color wager and the one or more additional wagers is $50 USD.

5. The method of claim 1, wherein the available face value choices for the one or more additional wagers are:
(a) 2 through 6,
(b) 7 through Jack,
(c) Queen through King,
(d) Ace, and
(e) Joker.

6. The method of claim 5, wherein the payout for wagers that choose 2 through 6 and 7 through Jack is less than the payout for wagers that choose Queen through King, and wherein the payout for wagers that choose Queen through King is less than wagers that choose Ace or Jack.

7. The method of claim 1, wherein the payout is least for the color wager.

8. The method of claim 1, wherein:
the number of players playing the game is 1 to 5,
each player is required to place a color wager prior to the card being turned over, and
each player is provided with the option, prior to the card being turned over, to place one or more additional wagers predicting the face value of the card dealt face down on the table.

9. A method of playing a multi-round wagering card game comprising:
dealing a plurality of cards face down on a table;
performing a first round by:
requiring a player to place a color wager prior to any of the cards being turned over to reveal the face value of a first card;
providing the player with an option, prior to any of the cards being turned over, to place one or more additional wagers predicting the face value of the first card;
providing the player with an option, prior to any of the cards being turned over, to place a community wager that pays out if the plurality of cards form a Poker hand;
turning said first card over to reveal the card;
resolving the color wager by paying a payout based on the color wager if the first card is the same color as the color wager; and
resolving the one or more additional wagers if placed by paying a payout based on the one or more additional wagers if the value of the first card is the same as any of the predicted values;
performing a second round by:
requiring the player to place another color wager prior to turning over a next one of the cards that are dealt face down;
providing the player with an option, prior to said next card being turned over, to place one or more additional wagers predicting the face value of said next card;
turning said next card over to reveal the face value of said next card;
resolving said another color wager by paying a payout based on said another color wager if said next card is the same color as said another color wager; and
resolving the one or more additional wagers, if placed, by paying a payout based on the one or more additional wagers if the value of said next card is the same as any of the predicted values;
performing additional rounds until all of the cards that are dealt face down are turned over, the additional rounds being performed by repeating the steps performed in the second round; and
resolving the community wager, if placed, by paying a payout based the community wager if the plurality of cards form a Poker hand.

10. The method of claim 9, wherein the number of cards that are dealt face down is five.

11. The method of claim 9, wherein the number of rounds played for a game is three, and wherein all of the remaining cards are revealed after the third round and the community wager is settled after the remaining cards are revealed.

12. The method of claim 9, wherein the one or more additional wagers are limited to the color chosen in the color wager.

13. The method of claim 9, wherein the one or more additional wagers are limited to the color chosen in the color wager except for additional wagers predicting a Joker.

14. The method of claim 9, wherein a minimum bet for the color wager and the one or more additional wagers is $10 USD, and wherein the maximum bet for the color wager and the one or more additional wagers is $50 USD, and wherein the bet for the community wager is $5 USD.

15. The method of claim 1, wherein the available face value choices for the one or more additional wagers are:
(a) 2 through 6,
(b) 7 through Jack,
(c) Queen through King,
(d) Ace, and
(e) Joker.

16. The method of claim 15, wherein the payout for wagers that choose 2 through 6 and 7 through Jack is less than the payout for wagers that choose Queen through King, and wherein the payout for wagers that choose Queen through King is less than wagers that choose Ace or Jack.

17. The method of claim 9, wherein the Poker hands include, Five of a Kind, Royal Flush, Straight Flush, Four of a Kind, Full House, Flush, Straight, and All the same color.

18. The method of claim 17, wherein a Royal Flush with a Joker has a different payout from a Royal Flush without a Joker.

19. The method of claim 9, wherein the payout is least for the color wager.

20. The method of claim 9, wherein:
the number of players playing the game is 1 to 5,
each player is required to place a color wager prior to said next card being turned over,
each player is provided, prior to said next card being turned over, with the option to place one or more additional wagers predicting the face value of the card dealt face down on the table, and
each player is provided, prior to any of the cards being turned over, with the option to place a community wager that pays out if the plurality of cards form a Poker hand.
